(19) United States
(12) Patent Application Publication
(10) Pub. No.: US 2019/0060942 A1
(43) Pub. Date: Feb. 28, 2019

(54) AUTOMATIC HUB FORGING DIE LUBRICANT CLEANING DEVICE

(71) Applicant: CITIC Dicastal CO.,LTD., Qinhuangdao (CN)

(72) Inventors: Jinling Yang, Qinhuangdao (CN); Li Yang, Qinhuangdao (CN); Baomin Su, Qinhuangdao (CN); Haifeng Li, Qinhuangdao (CN); Bicheng Ding, Qinhuangdao (CN); Yongwang Zhao, Qinhuangdao (CN)

(21) Appl. No.: 15/802,573

(22) Filed: Nov. 3, 2017

(30) Foreign Application Priority Data
Aug. 27, 2017 (CN) 201710746860.3

(51) Int. Cl. B05B 15/02; B21J 3/00; B08B 1/00; B08B 3/04

(52) U.S. Cl. CPC B05B 15/0258; B21J 3/00; B21K 1/40; B08B 3/04; B08B 1/005

(57) ABSTRACT

Disclosed is an improved automatic hub forging die lubricant cleaning device, comprising a lifting hydraulic cylinder, a limiting block, a hinge A, a hydraulic piston rod, a fixed connecting rod, a hinge shaft, a connecting plate, a hydraulic cylinder, a hinge B and the like. The device has the advantages that the labor efficiency is improved, the production intensity is reduced, and the generality is strong; and corresponding cleaning scrapers can be set according to the surface shapes of different hub dies and only need to be replaced via general bolt connectors, so that the cost of equipment is reduced.

### CROSS-REFERENCE TO RELATED APPLICATIONS

This application is filed based upon and claims priority to Chinese Patent Application No. 201710746860.3, filed on Aug. 27, 2017, the entire contents of which are incorporated herein by reference.

### BACKGROUND

When a hub is forged, an oil graphite lubricant needs to be sprayed onto the surface of a forged product forming die to meet effective flowing of forging materials. The oil graphite lubricant is high in surface viscosity, strong in adhesion and difficult to clean. At present, the oil graphite lubricant is cleaned by personnel using manual tools, and the forging die is high in temperature, so the labor intensity of workers in cleaning is high, much time and effort are required and the efficiency is low.

### SUMMARY

The disclosure relates to a cleaning device, specifically to a graphite lubricant cleaning device.

The disclosure is aimed at providing an improved automatic hub forging die lubricant cleaning device.

An improved automatic hub forging die lubricant cleaning device includes a lifting hydraulic cylinder, a limiting block, a hinge A, a hydraulic piston rod, a fixed connecting rod, a hinge shaft, a connecting plate, a hydraulic cylinder, a hinge B, a hydraulic cylinder fixing seat, a lubricant cleaning scraper, a main body frame, a support crossbeam, a die supporting tray, a servo motor, a foundation crossbeam, bases, rolling bearings, a left lubricant cleaning scraper, a bolt A, a left hydraulic cylinder assembly, a guide post, a guide sleeve, a plugging lockpin, a lifting hydraulic cylinder supporting crossbeam, a brush lifting hydraulic cylinder, a lifting bracket, a brush servo motor, a linear guide rail, a translation hydraulic cylinder, a horizontal bracket, a connecting key, a bolt B, a connecting sleeve, a ball brush fixer, a steel ball brush, a detergent storage tank, a nozzle, a middle upright post and a fixed plate.

The main body frame is of a structure including four upright posts and an upper crossbeam, a middle crossbeam and a lower crossbeam, the support crossbeam is the middle crossbeam, and the foundation crossbeam is the lower crossbeam. The servo motor is fixed below a large plate of the support crossbeam, the shaft of the servo motor is connected with the lower rotating shaft of the die supporting tray, and the die supporting tray is attached to the bottom of a die. Two positioning pins are arranged on the die supporting tray, and the positioning pins are connected with bottom positioning holes of the die to ensure that the die supporting tray drives the die to rotate. The rolling bearings are arranged below the die supporting tray and on the large plate of the support crossbeam to ensure the die supporting tray rotates at a low speed. The left hydraulic cylinder assembly is arranged on an upright post plate on the left side of an upright post of the main body frame via a connecting screw, and the left lubricant cleaning scraper is connected with the piston rod of the left hydraulic cylinder assembly. The hydraulic cylinder fixing seat is fixed in the middle of the right side of the main body frame, the hydraulic cylinder is connected with the hydraulic cylinder fixing seat via the hinge shaft, the hydraulic piston rod is connected with the fixed connecting rod via the hinge A, the fixed connecting rod is fixedly connected with the lifting hydraulic cylinder supporting crossbeam, the fixed connecting rod rotates under the action of the hydraulic cylinder by using the hinge shaft as a shaft, the limiting block is connected to the guide post, the guide post is connected with the connecting plate, and the connecting plate is connected with the lubricant cleaning scraper.

The guide sleeve is arranged in the lifting hydraulic cylinder supporting crossbeam; when the lifting hydraulic cylinder supporting crossbeam is horizontal, the plugging lockpin is plugged into the left upright post of the main body frame; and the lifting hydraulic cylinder supporting crossbeam is horizontally fixed to keep stable. The brush lifting hydraulic cylinder is connected with the lifting bracket and arranged on the horizontal bracket, and the brush lifting hydraulic cylinder drives the brush servo motor to be dragged up and down along the linear guide rail. The translation hydraulic cylinder is arranged on the fixed plate and the middle upright post, and the translation hydraulic cylinder is connected with the horizontal bracket and horizontally dragged along the linear guide rail. The connecting sleeve is connected with the main shaft of the servo motor by the connecting key and the bolt B. The steel ball brush is arranged below the ball brush fixer, the ball brush fixer is connected with the connecting sleeve, the nozzle is connected with the detergent storage tank via a rubber tube, and the nozzle is arranged in the middle of the upright post in a manner of tilting degrees to just spray a detergent to the working surface of the die.

In actual use, the fixed connecting rod is fixed with the lifting hydraulic cylinder supporting crossbeam, the switch of the hydraulic cylinder is shifted to a state that the hydraulic piston rod retracts, and the fixed connecting rod and the lifting hydraulic cylinder supporting crossbeam rotate degrees and are opened, taking the hinge shaft as a shaft, as shown in FIG. 2.

The die to be cleaned is placed on the supporting tray in tight fit. Two positioning pins on the die supporting tray are inserted into the bottom positioning holes of the die to ensure that the rotation of the supporting tray drives the die to rotate, and the rolling bearings are arranged below the die supporting tray and on the large plate of the support crossbeam to ensure the die supporting tray rotates steadily. Then, the detergent spray switch of the detergent storage tank is opened, and the nozzle sprays a detergent to the working surface of the die. The switch of the servo motor is turned on, and the motor shaft rotates to drive the die to rotate. Later, the detergent is sprayed to the surface of the die, minutes is waited for appropriately softening the lubricant on the surface of the die, the lifting hydraulic cylinder supporting crossbeam is switched to a closed state, the hydraulic piston rod stretches out under the action of the hydraulic cylinder, and the fixed connecting rod and the lifting hydraulic cylinder supporting crossbeam rotate degrees; when the lifting hydraulic cylinder supporting crossbeam is horizontal, the plugging lockpin is plugged into the left upright post of the main body frame, and the lifting hydraulic cylinder supporting crossbeam is horizontally fixed to keep stable, as shown in FIG. 1.

The piston of the lifting hydraulic cylinder drives the connecting plate and the lubricant cleaning scraper to descend under the guiding effects of the guide post and the guide sleeve and to gradually contact the surface of the die, the main shaft of the servo motor drives the die to rotate, and in the whole process, the lubricant cleaning scraper downward gradually contacts the surface of the die to clean the lubricant thereon till the cleaning ends. Meanwhile, the piston rod of the left hydraulic cylinder assembly and the left lubricant cleaning scraper on the side stretch out to scrape the lubricant on the side surface of the die till the cleaning ends. The working profiles of the lubricant cleaning scrapers are formed by linear cutting along with the surface shape of the die to ensure that the lubricant on the surface of the die can be scraped.

In next working step, the servo motor is turned off, and the die stops rotating. The lifting hydraulic cylinder drives the lubricant cleaning scraper to upward retract to the top, the fixed connecting rod and the lifting hydraulic cylinder supporting crossbeam are welded into a whole, and taking the hinge shaft as a rotating shaft, under the condition that the switch of the hydraulic cylinder is shifted to ensure the hydraulic piston rod retracts, the fixed connecting rod and the lifting hydraulic cylinder supporting crossbeam rotate degrees and are opened, as shown in FIG. 2.

The switch of the servo motor is turned on, and the servo motor drives the die to rotate. The motor of the detergent storage tank is turned on, and the detergent is sprayed to the working surface of the die via the rubber tube and the nozzle. The translation hydraulic cylinder is arranged on the fixed plate and the middle upright post, the translation hydraulic cylinder is connected with the horizontal bracket, and the horizontal bracket is horizontally dragged along the linear guide rail to enter the space above the die. The brush lifting hydraulic cylinder is connected with the lifting bracket and arranged on the horizontal bracket, the brush lifting hydraulic cylinder drives the brush servo motor via the lifting bracket to be dragged down along the linear guide rail, and the connecting sleeve is connected with the main shaft of the servo motor by the connecting key and the bolt B. The servo motor is switched to be turned on, the main shaft rotates and drives the ball brush fixer to be connected with the connecting sleeve, the steel ball brush rotates to clean the surface of the die, the whole process is controlled by a PLC to realize horizontal and up-down feeding or retraction of the head of the steel ball brush, the purpose of cleaning the surface of the die is fulfilled, rotation of all the motors is stopped under the control of the PLC after cleaning, and the die is wiped with cotton cloth and then taken down.

Compared with existing manual cleaning, the disclosure has the advantages that the labor efficiency is improved, the production intensity is reduced, and the generality is strong; corresponding cleaning scrapers can be set according to the surface shapes of different hub dies and only need to be replaced via general bolt connectors, so that the cost of equipment is reduced; and the positioning pins on the supporting tray and the bottom positioning holes of the die are standard, so that different types of dies can be commonly used and positioned.

### BRIEF DESCRIPTION OF THE DRAWINGS

FIG. 1 is a front schematic diagram of an improved automatic hub forging die lubricant cleaning device of the disclosure.

FIG. 2 is a side schematic diagram of the improved automatic hub forging die lubricant cleaning device of the disclosure.

FIG. 3 is a schematic diagram of an upper opened state of the improved automatic hub forging die lubricant cleaning device of the disclosure.

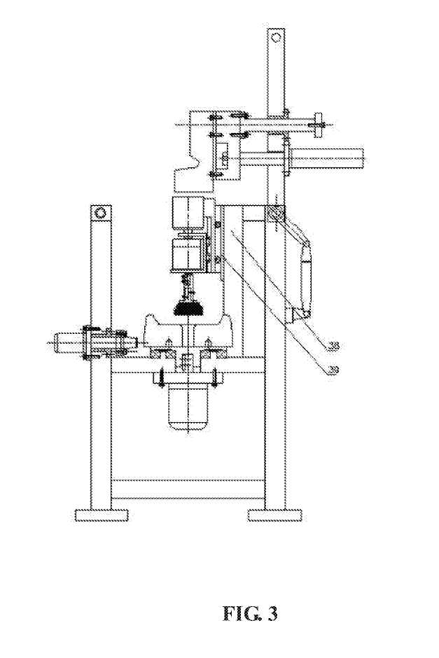

In which: 1—lifting hydraulic cylinder, 2—limiting block, 3—hinge A, 4—hydraulic piston rod, 5—fixed connecting rod, 6—hinge shaft, 7—connecting plate, 8—hydraulic cylinder, 9—hinge B, 10—hydraulic cylinder fixing seat, 11—lubricant cleaning scraper, 12—main body frame, 13—die, 14—support crossbeam, 15—die supporting tray, 16—servo motor, 17—foundation crossbeam, 18—base, 19—rolling bearing, 20—left lubricant cleaning scraper, 21—bolt A, 22—left hydraulic cylinder assembly, 23—guide post, 23-1—guide sleeve, 24—plugging lockpin, 25—lifting hydraulic cylinder supporting crossbeam, 26—brush lifting hydraulic cylinder, 27—lifting bracket, 28—brush servo motor, 29—linear guide rail, 30—translation hydraulic cylinder, 30-1—horizontal bracket, 31—connecting key, 32—bolt B, 33—connecting sleeve, 34—ball brush fixer, 35—steel ball brush, 36—detergent storage tank, 37—nozzle, 38—middle upright post, 39—fixed plate.

### DETAILED DESCRIPTION

Details and works of a specific device provided by the disclosure will be described in detail below in combination with the accompanying drawings.

An improved automatic hub forging die lubricant cleaning device includes a lifting hydraulic cylinder 1, a limiting block 2, a hinge A 3, a hydraulic piston rod 4, a fixed connecting rod 5, a hinge shaft 6, a connecting plate 7, a hydraulic cylinder 8, a hinge B 9, a hydraulic cylinder fixing seat 10, a lubricant cleaning scraper 11, a main body frame 12, a support crossbeam 14, a die supporting tray 15, a servo motor 16, a foundation crossbeam 17, bases 18, rolling bearings 19, a left lubricant cleaning scraper 20, a bolt A 21, a left hydraulic cylinder assembly 22, a guide post 23, a guide sleeve 23-1, a plugging lockpin 24, a lifting hydraulic cylinder supporting crossbeam 25, a brush lifting hydraulic cylinder 26, a lifting bracket 27, a brush servo motor 28, a linear guide rail 29, a translation hydraulic cylinder 30, a horizontal bracket 30-1, a connecting key 31, a bolt B 32, a connecting sleeve 33, a ball brush fixer 34, a steel ball brush 35, a detergent storage tank 36, a nozzle 37, a middle upright post 38 and a fixed plate 39.

The main body frame 12 is of a structure including four upright posts and an upper crossbeam, a middle crossbeam and a lower crossbeam, the support crossbeam 14 is the middle crossbeam, and the foundation crossbeam 17 is the lower crossbeam. The servo motor 16 is fixed below a large plate of the support crossbeam 14, the shaft of the servo motor 16 is connected with the lower rotating shaft of the die supporting tray 15, and the die supporting tray 15 is attached to the bottom of a die 13. Two positioning pins are arranged on the die supporting tray 15, and the positioning pins are connected with bottom positioning holes of the die 13 to ensure that the die supporting tray 15 drives the die 13 to rotate. The rolling bearings 19 are arranged below the die supporting tray 15 and on the large plate of the support crossbeam 14 to ensure the die supporting tray 15 rotates at a low speed. The left hydraulic cylinder assembly 22 is arranged on an upright post plate on the left side of an upright post of the main body frame 12 via a connecting screw, and the left lubricant cleaning scraper 20 is connected with the piston rod of the left hydraulic cylinder assembly 22. The hydraulic cylinder fixing seat 10 is fixed in the middle of the right side of the main body frame 12, the hydraulic cylinder 8 is connected with the hydraulic cylinder fixing seat 10 via the hinge shaft 6, the hydraulic piston rod 4 is connected with the fixed connecting rod 5 via the hinge A 3, the fixed connecting rod 5 is fixedly connected with the lifting hydraulic cylinder supporting crossbeam 25, the fixed connecting rod 5 rotates under the action of the hydraulic cylinder 8 by using the hinge shaft 6 as a shaft, the limiting block 2 is connected to the guide post 23, the guide post 23 is connected with the connecting plate 7, and the connecting plate 7 is connected with the lubricant cleaning scraper 11.

The guide sleeve 23-1 is arranged in the lifting hydraulic cylinder supporting crossbeam 25; when the lifting hydraulic cylinder supporting crossbeam 25 is horizontal, the plugging lockpin 24 is plugged into the left upright post of the main body frame 12; and the lifting hydraulic cylinder supporting crossbeam 25 is horizontally fixed to keep stable. The brush lifting hydraulic cylinder 26 is connected with the lifting bracket 27 and arranged on the horizontal bracket 30-1, and the brush lifting hydraulic cylinder 26 drives the brush servo motor 28 to be dragged up and down along the linear guide rail. The translation hydraulic cylinder 30 is arranged on the fixed plate 39 and the middle upright post 38, and the translation hydraulic cylinder 30 is connected with the horizontal bracket 30-1 and horizontally dragged along the linear guide rail 29. The connecting sleeve 33 is connected with the main shaft of the servo motor 28 by the connecting key 31 and the bolt B 32. The steel ball brush 35 is arranged below the ball brush fixer 34, the ball brush fixer 34 is connected with the connecting sleeve 33, the nozzle 37 is connected with the detergent storage tank 36 via a rubber tube, and the nozzle 37 is arranged in the middle of the upright post in a manner of tilting 45 degrees to just spray a detergent to the working surface of the die 13.

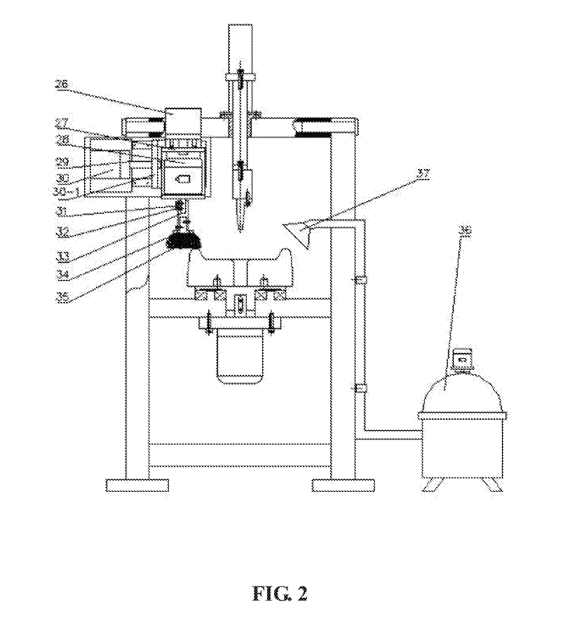

In actual use, the fixed connecting rod 5 is fixed with the lifting hydraulic cylinder supporting crossbeam 25, the switch of the hydraulic cylinder 8 is shifted to a state that the hydraulic piston rod 4 retracts, and the fixed connecting rod 5 and the lifting hydraulic cylinder supporting crossbeam 25 rotate 90 degrees and are opened, taking the hinge shaft 6 as a shaft, as shown in FIG. 2.

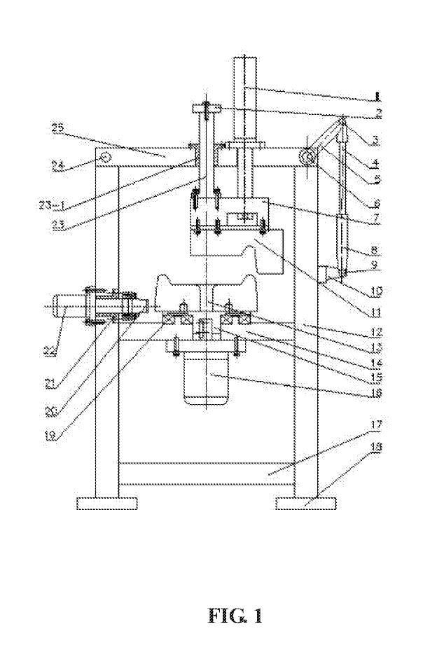

The die 13 to be cleaned is placed on the supporting tray 15 in tight fit. Two positioning pins on the die supporting tray 15 are inserted into the bottom positioning holes of the die 13 to ensure that the rotation of the supporting tray 15 drives the die 13 to rotate, and the rolling bearings 19 are arranged below the die supporting tray 15 and on the large plate of the support crossbeam 14 to ensure the die supporting tray 15 rotates steadily. Then, the detergent spray switch of the detergent storage tank 36 is opened, the nozzle 37 sprays a detergent to the working surface of the die 13. The switch of the servo motor 16 is turned on, and the motor shaft rotates to drive the die 13 to rotate. Later, the detergent is sprayed to the surface of the die 13, 10 minutes is waited for appropriately softening the lubricant on the surface of the die 13, the lifting hydraulic cylinder supporting crossbeam 25 is switched to a closed state, the hydraulic piston rod 4 stretches out under the action of the hydraulic cylinder 8, and the fixed connecting rod 5 and the lifting hydraulic cylinder supporting crossbeam 25 rotate 90 degrees; when the lifting hydraulic cylinder supporting crossbeam 25 is horizontal, the plugging lockpin 24 is plugged into the left upright post of the main body frame 12, and the lifting hydraulic cylinder supporting crossbeam 25 is horizontally fixed to keep stable, as shown in FIG. 1.

The piston 1 of the lifting hydraulic cylinder 1 drives the connecting plate 7 and the lubricant cleaning scraper 11 to descend under the guiding effects of the guide post 23 and the guide sleeve 23-1 and to gradually contact the surface of the die 13, the main shaft of the servo motor 16 drives the die 13 to rotate, and in the whole process, the lubricant cleaning scraper 11 downward gradually contacts the surface of the die 13 to clean the lubricant thereon till the cleaning ends. Meanwhile, the piston rod of the left hydraulic cylinder assembly 22 and the left lubricant cleaning scraper 20 on the side stretch out to scrape the lubricant on the side surface of the die till the cleaning ends. The working profiles of the lubricant cleaning scrapers are formed by linear cutting along with the surface shape of the die 13 to ensure that the lubricant on the surface of the die 13 can be scraped.

In next working step, the servo motor 16 is turned off, and the die 13 stops rotating. The lifting hydraulic cylinder 1 drives the lubricant cleaning scraper 11 to upward retract to the top, the fixed connecting rod 5 and the lifting hydraulic cylinder supporting crossbeam 25 are welded into a whole, and taking the hinge shaft 6 as a rotating shaft, under the condition that the switch of the hydraulic cylinder 8 is shifted to ensure the hydraulic piston rod 4 retracts, the fixed connecting rod 5 and the lifting hydraulic cylinder supporting crossbeam 25 rotate 90 degrees and are opened, as shown in FIG. 2.

The switch of the servo motor 16 is turned on, and the servo motor 16 drives the die 13 to rotate. The motor of the detergent storage tank 36 is turned on, and the detergent is sprayed to the working surface of the die 13 via the rubber tube and the nozzle 37. The translation hydraulic cylinder 30 is arranged on the fixed plate 39 and the middle upright post 38, the translation hydraulic cylinder 30 is connected with the horizontal bracket 30-1, and the horizontal bracket 30-1 is horizontally dragged along the linear guide rail 29 to enter the space above the die. The brush lifting hydraulic cylinder 26 is connected with the lifting bracket 27 and arranged on the horizontal bracket 30-1, the brush lifting hydraulic cylinder 26 drives the brush servo motor 28 via the lifting bracket 27 to be dragged down along the linear guide rail, and the connecting sleeve 33 is connected with the main shaft of the servo motor 28 by the connecting key 31 and the bolt B 32. The servo motor 28 is switched to be turned on, the main shaft rotates and drives the ball brush fixer 34 to be connected with the connecting sleeve 33, the steel ball brush 35 rotates to clean the surface of the die 13, the whole process is controlled by a PLC to realize horizontal and up-down feeding or retraction of the head of the steel ball brush 35, the purpose of cleaning the surface of the die 13 is fulfilled, rotation of all the motors is stopped under the control of the PLC after cleaning, and the die 13 is wiped with cotton cloth and then taken down.

Compared with existing manual cleaning, the disclosure has the advantages that the labor efficiency is improved, the production intensity is reduced, and the generality is strong; corresponding cleaning scrapers can be set according to the surface shapes of different hub dies and only need to be replaced via general bolt connectors, so that the cost of equipment is reduced; and the positioning pins on the supporting tray 15 and the bottom positioning holes of the die are standard, so that different types of dies can be commonly used and positioned.

1. An improved automatic hub forging die lubricant cleaning device, comprising a lifting hydraulic cylinder, a limiting block, a hinge A, a hydraulic piston rod, a fixed connecting rod, a hinge shaft, a connecting plate, a hydraulic cylinder, a hinge B, a hydraulic cylinder fixing seat, a lubricant cleaning scraper, a main body frame, a support crossbeam, a die supporting tray, a servo motor, a foundation crossbeam, bases, rolling bearings, a left lubricant cleaning scraper, a bolt A, a left hydraulic cylinder assembly, a guide post, a guide sleeve, a plugging lockpin, a lifting hydraulic cylinder supporting crossbeam, a brush lifting hydraulic cylinder, a lifting bracket, a brush servo motor, a linear guide rail, a translation hydraulic cylinder, a horizontal bracket, a connecting key, a bolt B, a connecting sleeve, a ball brush fixer, a steel ball brush, a detergent storage tank, a nozzle, a middle upright post and a fixed plate, wherein:
the main body frame is of a structure comprising four upright posts and an upper crossbeam, a middle crossbeam and a lower crossbeam, the support crossbeam is the middle crossbeam, and the foundation crossbeam is the lower crossbeam; the servo motor is fixed below a large plate of the support crossbeam, the shaft of the servo motor is connected with the lower rotating shaft of the die supporting tray, and the die supporting tray is attached to the bottom of a die; two positioning pins are arranged on the die supporting tray, and the positioning pins are connected with bottom positioning holes of the die to ensure that the supporting tray drives the die to rotate; the rolling bearings are arranged below the die supporting tray and on the large plate of the support crossbeam to ensure the die supporting tray rotates at a low speed; the left hydraulic cylinder assembly is arranged on an upright post plate on the left side of an upright post of the main body frame via a connecting screw, and the left lubricant cleaning scraper is connected with the piston rod of the left hydraulic cylinder assembly; the hydraulic cylinder fixing seat is fixed in the middle of the right side of the main body frame, the hydraulic cylinder is connected with the hydraulic cylinder fixing seat via the hinge shaft, the hydraulic piston rod is connected with the fixed connecting rod via the hinge A, the fixed connecting rod is fixedly connected with the lifting hydraulic cylinder supporting crossbeam, the fixed connecting rod rotates under the action of the hydraulic cylinder by using the hinge shaft as a shaft, the limiting block is connected to the guide post, the guide post is connected with the connecting plate, and the connecting plate is connected with the lubricant cleaning scraper;
the guide sleeve is arranged in the lifting hydraulic cylinder supporting crossbeam; when the lifting hydraulic cylinder supporting crossbeam is horizontal, the plugging lockpin is plugged into the left upright post of the main body frame; the lifting hydraulic cylinder supporting crossbeam is horizontally fixed to keep stable; the brush lifting hydraulic cylinder is connected with the lifting bracket and arranged on the horizontal bracket, and the brush lifting hydraulic cylinder drives the brush servo motor to be dragged up and down along the linear guide rail; the translation hydraulic cylinder is arranged on the fixed plate and the middle upright post, and the translation hydraulic cylinder is connected with the horizontal bracket and horizontally dragged along the linear guide rail; the connecting sleeve is connected with the main shaft of the servo motor by the connecting key and the bolt B; the steel ball brush is arranged below the ball brush fixer, the ball brush fixer is connected with the connecting sleeve, the nozzle is connected with the detergent storage tank via a rubber tube, and the nozzle is arranged in the middle of the upright post in a manner of tilting 45 degrees to just spray a detergent to the working surface of the die.
